(19) United States
(12) Patent Application Publication
(10) Pub. No.: US 2006/0088242 A1
(43) Pub. Date: Apr. 27, 2006

(54) Optical switches with uniaxial mirrors

(76) Inventor: Vlad Novotny, Los Gatos, CA (US)

Correspondence Address: ARTHUR J. BEHIEL, 6601 KOLL CENTER PARKWAY, SUITE 245, PLEASANTON, CA, 94566, US

(21) Appl. No.: 11/298,229

(22) Filed: Dec. 8, 2005

Related U.S. Application Data
(63) Continuation of application No. 10/751,160, filed on Dec. 31, 2003.

(51) Int. Cl. G02B 6/26

(52) U.S. Cl. 385/18

(57) ABSTRACT

Described are various optical, opto-electrical and electrical components and subsystems. Micro-Electro-Mechanical Systems (MEMS) actuators that employ electrostatic combs adjust uniaxial, unidirectional or bidirectional mirrors between two basic positions with optical power control, one position for each of two switch configurations. Limiting the switching mirrors to two positions limits flexibility, but greatly reduces system cost and complexity, and simplifies beam alignment. In one embodiment, a frame surrounding the comb teeth maintains spacing between teeth to prevent electrical shorts.

### BACKGROUND

As the result of continuous advances in technology, particularly in the area of networking, such as the Internet, there is an increasing demand for communications bandwidth. For example, the transmission of images or video over the Internet, the transfer of large amounts of data in transaction processing, or videoconferencing implemented over a public telephone network typically require the high speed transmission of large amounts of data. As applications such as these become more prevalent, the demand for communications bandwidth will only increase.

Optical waveguides, including optical fibers, offer transmission media that are well suited to meet this increasing demand. Optical waveguides have an inherent bandwidth much greater than metal-based conductors, such as twisted-pair or coaxial cable. To exploit this bandwidth, modern optical waveguides transmit information simultaneously using multiple wavelengths. Because optical networks do not generally have a single continuous optical fiber from every source to every destination, light signals are switched as they travel through an optical network. Previously, this switching was accomplished using optical-electrical-optical (“OEO”) systems, where a light signal was converted to an electrical signal, switched electrically, and then converted back to light and conveyed optically. OEO systems are relatively large, complex, and expensive; more seriously, the bandwidth limitations of the electronic portion of OEO switches and the need to perform signal conversions introduce undesirable bottlenecks.

Much effort is being expended on the development of all-optical cross-connect switching systems, some of which employ arrays of electrostatically, electromagnetically, piezoelectrically, or thermally actuated mirrors. For detailed discussions of some such systems, see U.S. Pat. No. 6,539,148 to Kim et al., U.S. Pat. No. 5,974,207 to Aksyuk et al., and U.S. Pat. No. 6,625,341 to Novotny, all of which are incorporated herein by reference.

Some of the conventional systems described in the above-referenced patents work well, and have achieved a degree of commercial success. Still, optical switching systems are complex, typically including two-dimensional position sensing arrays, servo systems, expensive driving electronics, and arrays of multi-axial actuators that are difficult to fabricate. These problems might be ameliorated, and the associated costs reduced, by improved device integration and further simplification of existing technologies. There thus remains a need for reliable optical components and switching systems that can be produced with reduced per-channel costs.

### SUMMARY

The present invention addresses the need for small, reliable optical subsystems that can be integrated to produce separately or in combination optical switching systems, variable optical attenuators, and gain equalizers with improved manufacturability and performance. Some embodiments include Micro-Electro-Mechanical Systems (MEMS) actuators that employ electrostatic comb drives to adjust uniaxial mirrors between two basic positions, one position for each of two switch configurations. Limiting the switching mirrors to two basic positions limits flexibility, but greatly reduces system cost and complexity, and simplifies optical alignment. In one embodiment, dielectric ledges separate conductive layers and significantly improve electrical isolation leading to very low power dissipation. In some embodiments, each actuated member includes one or more counterbalances opposite the combs to reduce sensitivity to vibration and orientation.

Each actuator assembly also includes an actuated member flexibly connected to a substrate. The actuated member and the substrate include electrically isolated, interdigitated, comb electrodes. The actuated member can be moved relative to the substrate along an axis by applying a potential between a fixed combs of the substrate and the movable combs of the actuated member.

In one embodiment, the hinges interconnecting the actuated member and the substrate are made using the same conductive layers as the movable combs. The process used to form the hinges may differ from the process used to form the combs, however. For example, the hinges may be made thinner to reduce the amount of torque required to move the actuated member. In another embodiment, serpentine hinges are employed to provide lower stiffness. In yet another embodiment, hinges with width greater than thickness and hinge thickness lower than movable comb thickness shift translational instability to higher driving voltages, thus permitting larger actuator deflections.

Some embodiments combine optical switching, optical attenuation, and optical power equalization to facilitate optical system integration. A two-by-two switch in accordance with one such embodiment, for example, includes two switch positions: IN1→OUT1/IN2→OUT2 and IN1→OUT2/IN2→OUT1. Each switch position is slightly variable to provide a degree of variable optical attenuation or equalization. Combining switching with attenuation, equalization, or both advantageously reduces the expense and complexity of components required to build a number of optical systems. Some embodiments include active, closed-loop control mechanisms that can dynamically alter the degree of attenuation applied to one or more beams to maximize light output, maintain stable output intensities despite input fluctuations, or equalize output intensities for a number of outgoing beams.

This summary does not limit the invention, which is instead defined by the claims.

### BRIEF DESCRIPTION OF THE FIGURES

FIGS. 1A and 1B depict an optical switching system 100 in accordance with one embodiment.

FIG. 2 depicts a two-by-two switching system 200 that doubles as an optical power equalizer.

FIG. 3A is a plan view of a uniaxial, Micro-Electro-Mechanical Systems (MEMS) actuator 300 used to implement the bi-stable mirrors of FIGS. 1A, 1B, and 2 in accordance with one embodiment.

FIG. 3B is a cross section of actuator 300 of FIG. 3A taken along line A-A′ of FIG. 3A.

FIG. 4 depicts a mirror array 400 that includes two symmetrical actuators 405 and 410, both of which are similar to actuator 300 of FIG. 3A.

FIG. 5 depicts a switching system 500 illustrating how arrays of bi-stable mirrors of the type described above can be combined to form complex reconfigurable switches, such as Reconfigurable Optical Add Drop Multiplexers (ROADMs).

FIG. 6 depicts a mirror array 600 in accordance with another embodiment.

FIGS. 7A-7P depict a process sequence used to form one or an array of mirrors in accordance with some embodiments.

FIG. 8A depicts a uniaxial, bi-directional actuator 800 in accordance with another embodiment.

FIG. 8B is a plan view depicting a portion of actuator 800 with the top conductive layer removed to show the underlying pairs of fixed combs 830 and 833.

FIG. 8C is a cross section of actuator 800 taken along line B-B′ of FIG. 8A.

FIG. 9 depicts an optical attenuator 900 that includes an input fiber 905, and output fiber 910, a lens 915, and an actuator 920 similar to one of the uni-axial mirrors described herein.

FIG. 10 depicts an optical switch 1000 that includes an input fiber 1005 and n output fibers 0₁ through 0ₙ.

FIG. 11 depicts an optical switch 1100 in which an actuator 1105 switches a beam from an input fiber IN to one of four output fibers 0₁ through 0₄.

FIGS. 12A and 12B depict two positions of an ADD/DROP multiplexer 1200 in accordance with one embodiment.

### DETAILED DESCRIPTION

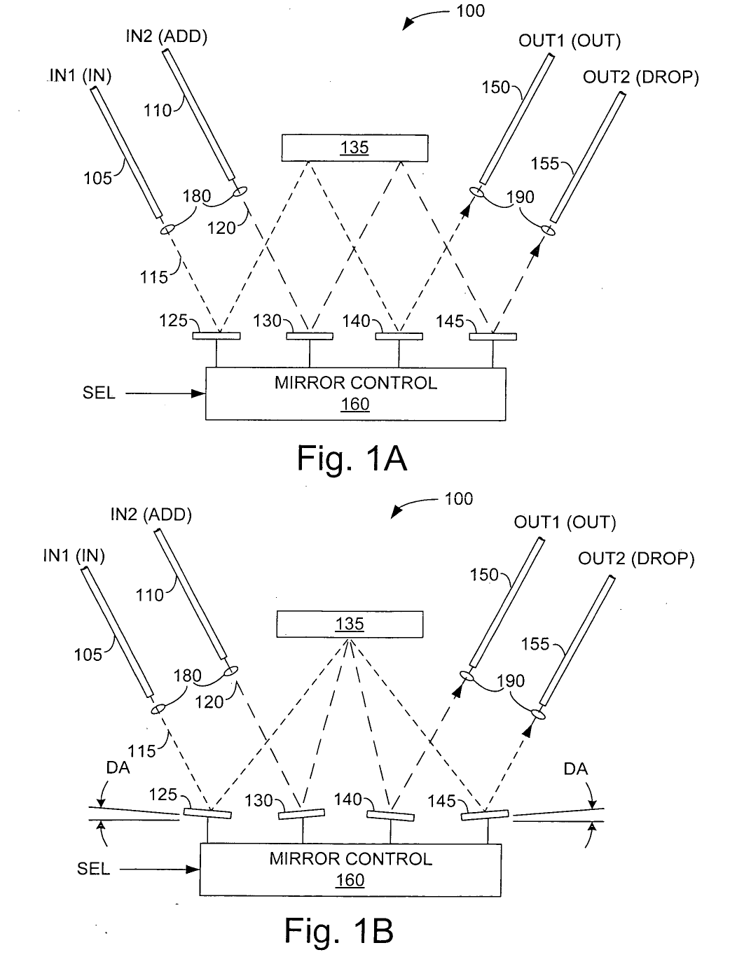

FIGS. 1A and 1B depict an optical switching system 100 in accordance with one embodiment. System 100 includes first and second waveguides 105 and 110 emitting respective first and second optical beams 115 and 120, first and second bi-stable mirrors 125 and 130 that direct beams 115 and 120 toward a folding mirror 135, and third and fourth bi-stable mirrors 140 and 145 that direct the beams reflected from folding mirror 135 into third and fourth waveguides 150 and 155. The four waveguides are optical fibers in this example, but one or more might be other types of waveguides.

Mirror control circuitry 160 controls the positions of bi-stable mirrors 125, 130, 140, and 145 to support two switch states: in the first state, depicted in FIG. 1A, bi-stable mirrors 125 and 140 direct first beam 115 toward waveguide 150 and mirrors 130 and 145 direct second beam 120 toward waveguide 155 (i.e., IN1→OUT1 and IN2→OUT2); in the second switch position, depicted in FIG. 1B, mirrors 125 and 145 direct first beam 115 toward waveguide 155 and mirrors 130 and 140 direct second beam 120 toward waveguide 150 (i.e., IN1→OUT2 and IN2→OUT1). Input lenses 180 collimate light beams exiting waveguides 105 and 110 and exit lenses 190 focus light beams back into waveguides 150 and 155.

Mirrors 125, 130, 140, and 145 are termed “bi-stable” because they accomplish the required switching using just two stable switching positions. These positions can be defined physically or electronically. In the depicted embodiment, each of the bi-stable mirrors pivots on a rotational axis normal to the page, and in operation is limited to the two possibilities depicted in FIGS. 1A and 1B. This is in contrast to more complex mirror arrays that employ multi-axis mirrors to relay input optical beams from one source fiber to a number of destination fibers. Limiting the switching mirrors to two stable positions limits flexibility, but greatly reduces system cost and complexity.

In the first switch position, shown in FIG. 1A, the reflective surfaces of mirrors 125, 130, 140, and 145 are substantially parallel to one another. System 100 may be assembled in this position and the various optical components aligned as necessary to maximize optical coupling of incoming beam 115 to outgoing waveguide 150 (IN1→OUT1) and incoming beam 120 to outgoing waveguide 155 (IN2→OUT2). In the second switch position, shown in FIG. 1B, bi-stable mirrors 125 and 140 are rotated clockwise by a deflection angle DA and mirrors 130 and 145 are rotated counterclockwise by the same angle DA. These adjustments swap the destinations of beams 115 and 120, reflecting beam 115 toward waveguide 155 (IN1→OUT2) and beam 110 toward waveguide 150 (IN2→OUT1). Alternatively, mirrors 130 and 145 can be rotated in the same direction as mirrors 125 and 140; however, deflection angles are increased by a factor of two compared with the previous case for the same configuration and dimensions of the system.

Switch system 100 can be used as an add/drop multiplexer. Add/drop multiplexers are well known, and are described in the above-referenced patent to Kim et al. Briefly, conventional add/drop multiplexers exhibit one of two states: either an input signal IN is conveyed to an output waveguide OUT, or signal IN is conveyed to a drop waveguide DROP and an add signal ADD is conveyed to output waveguide OUT (i.e., the first switch position is IN→OUT and the second is IN→DROP/ADD→OUT).

Added signals need not be dropped, so switching system 100 can be used in slightly different switch configurations than the ones shown in FIGS. 1A and 1B when exhibiting add/drop functionality. Assume, for example, that system 100 is employed as an add/drop multiplexer in which input IN1 receives input signals, input IN2 receives add signals, output OUT1 emits output signals, and output OUT2 emits dropped signals. In that case, when switch 100 is configured to simply pass input signal IN1, the optical path through switch system 100 is from IN1 to OUT1, or from waveguide 105 to waveguide 150. The ADD signal on input IN2 need not be conveyed to output OUT2, the DROP output, so mirrors 130 and 145 may be positioned differently than shown in FIG. 1A. When configured to add a signal ADD on input IN2 and drop input signal IN1, switching system 100 employs both signal paths, in which case switching system 100 is positioned in the manner depicted in FIG. 1B.

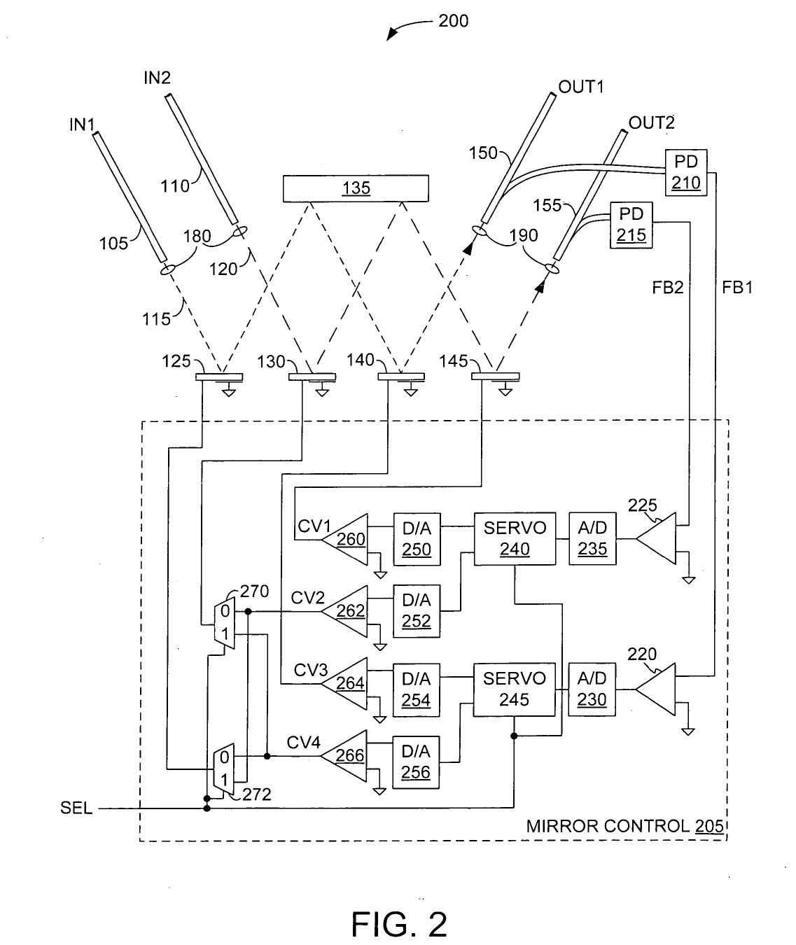

FIG. 2 depicts a two-by-two switching system 200 that, in accordance with one embodiment, doubles as an optical power equalizer. System 200 is similar to switching system 100 of FIGS. 1A and 1B, like-numbered elements being the same or similar. Switching system 200 combines variable optical attenuation with optical switching to reduce expense and complexity.

System 200 includes a control circuit 205 that, like control circuit 160 of FIGS. 1A and 1B, controls the deflection angles of mirrors 125, 130, 140, and 145 to select between two switching positions in response to a select signal SEL. Mirror control circuit 205 also tunes the angles of mirrors 125, 130, 140, and 145 in each switch position to maximize light output intensity or to maintain a constant light intensities OUT1 and OUT2 in one or both of waveguides 150 and 155 despite variations in the light intensity of beams 115 or 120, or to equalize output intensities for outputs OUT1 and OUT2.

Mirror control circuit 205 is part of a feedback circuit that includes a pair of conventional power detectors 210 and 215, each of which produces a respective feedback signal FB1 and FB2 proportional to the light intensity in the respective waveguide based on small signals split from waveguides 150 and 155. Operational amplifiers 220 and 225 amplify feedback signals FB1 and FB2 and provide the resulting feedback signals to respective analog-to-digital (A/D) converters 230 and 235. A pair of servo circuits 240 and 245 interprets the resulting digital feedback signals to provide corrective-attenuation signals to digital-to-analog (D/A) converters 250, 252, 254, and 256. Four operational amplifiers 260, 262, 264, and 266 then buffer the resulting corrective attenuation signals to produce four analog control voltages CV1, CV2, CV3, and CV4.

Amplifiers 260 and 264 convey respective control voltages CV1 and CV3 directly to mirrors 145 and 140, respectively, while amplifiers 262 and 266 convey control voltages CV3 and CV4 to mirrors 125 and 130 via a pair of two-to-one multiplexers 270 and 272. In the first switch position (SEL=0), the switch position illustrated in FIGS. 1A and 2, feedback signal FB1 affects the deflection angle of mirrors 125 and 140, while feedback signal FB2 affects the deflection angle of mirrors 130 and 145. In addition to providing the select signal for multiplexers 270 and 272, signal SEL controls servos 240 and 245, which are calibrated to establish course mirror actuation angles for each switch position. In the depicted example, servos 240 and 245 are calibrated such that the reflective surfaces of mirrors 125, 130, 140, and 145 are substantially parallel in the first switch position. If system 200 is accurately aligned, this position maximizes the optical coupling of beams 115 and 120 into respective output waveguides 150 and 155.

Slightly changing the angles of mirrors 125, 130, 140, and 145 changes the degree to which beams 115 and 120 are aligned with the outgoing waveguides, and consequently changes the output intensity of switching system 200. Servos 240 and 245 can be configured either to adjust control voltages CV1, CV2, CV3, and CV4 as necessary to maximize the output intensity of the beams through waveguides 150 and 155 or to maintain desired output intensities through those waveguides. In one embodiment, servos 240 and 245 respond to signals FB1 and FB2 by equalizing the output intensities through waveguides 150 and 155. Referring to beam 115 in the switch position of FIG. 2, for example, servo 245 controls the angles of mirrors 125 and 140 based upon feedback signal FB1 to maintain a relatively stable output intensity OUT1 despite intensity variations in beam 115. Servo 240 similarly controls the angles of mirrors 130 and 145 based upon feedback signal FB2 to maintain a relatively stable output intensity OUT2 despite intensity variations in beam 120. Servos 240 and 245 are interconnected, in one embodiment, to allow servos 240 and 245 to equalize the output intensities OUT1 and OUT2.

Though not shown, system 200 works in much the same way to control the intensities of the outgoing beams in the second switch position (SEL=1) depicted in FIG. 1B. In the second switch position, feedback signal FB1 affects the deflection angle of mirrors 130 and 140, while feedback signal FB2 affects the deflection angle of mirrors 125 and 145. As in the first switch position, servos 240 and 245 provide coarse settings for control voltages CV1, CV2, CV3, and CV4. The operation of system 200 is essentially the same in the second switch position as in the first, so a description of the operation of system 200 in the second switch position is omitted here for brevity.

Power detectors 210 and 215 receive a small percentage of the light passing through the corresponding output waveguide. To accomplish this, an optical splitter is formed or engaged to the output waveguide to split a fraction (e.g., a few percent) of the output beam to produce a monitor beam. The optical splitter may be implemented in various configurations. For example, a portion of a fiber waveguide may be side-polished to remove a portion of the fiber cladding to form an optical port. Optical energy from the port can then be evanescently coupled out of the output waveguide to produce the monitor beam. In another example, an angled fiber Bragg grating may be fabricated in the waveguide so that a small fraction of light is reflected in the direction normal to the optical axis of the waveguide to produce a monitor beam. In yet another example, a conventional fiber beam splitter or tap can be used. Other embodiments employ different position detectors, such as of the type described in the above-referenced Novotny patent. As compared with the more complex systems described in that patent, which include arrays of multi-axial mirrors switching between any input and any output fibers, position sensing is simplified in accordance with the embodiment of FIG. 2 because the movable mirrors only have one rotational axis and switch between just two outgoing waveguides.

System 200 does not require perfectly matched deflection angle/voltage characteristics of actuators 125, 130, 140, and 145. All four actuators can be controlled using the two feedback signals FB1 and FB2. In some embodiments, active mirror pairs can be controlled using the same control voltage. In an embodiment similar to that of FIG. 2, for example, control voltage CV1 can control both mirrors 130 and 145 and control voltage CV3 can control both mirror 125 and 140 in the depicted first switch position. Furthermore, depending upon alignment tolerances, all four actuators can be controlled by the same signal, e.g. with one voltage level providing the deflections depicted in FIG. 1A and a second voltage level providing the deflections depicted in FIG. 1B. In other embodiments, only one mirror in each beam path (e.g., mirrors 125 and 130) is employed to introduce misalignments. Servos 240 and 245 can be adapted to control pairs of mirrors simultaneously or sequentially. Many alternative control configurations are possible, as will be obvious to those of skill in the art.

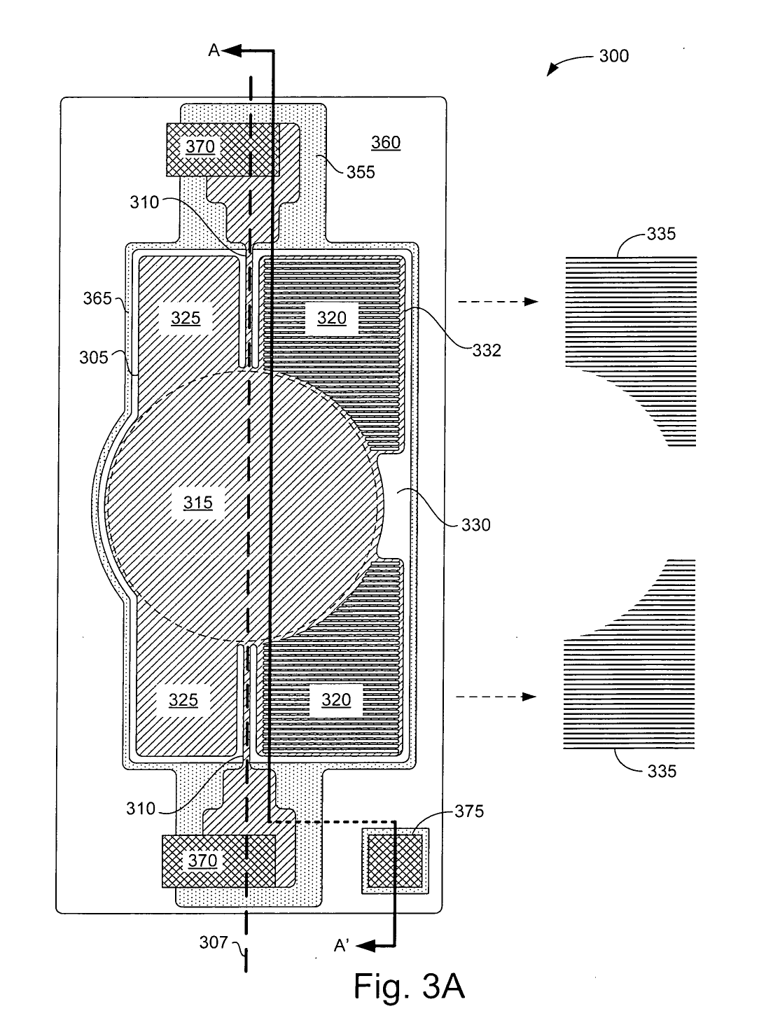

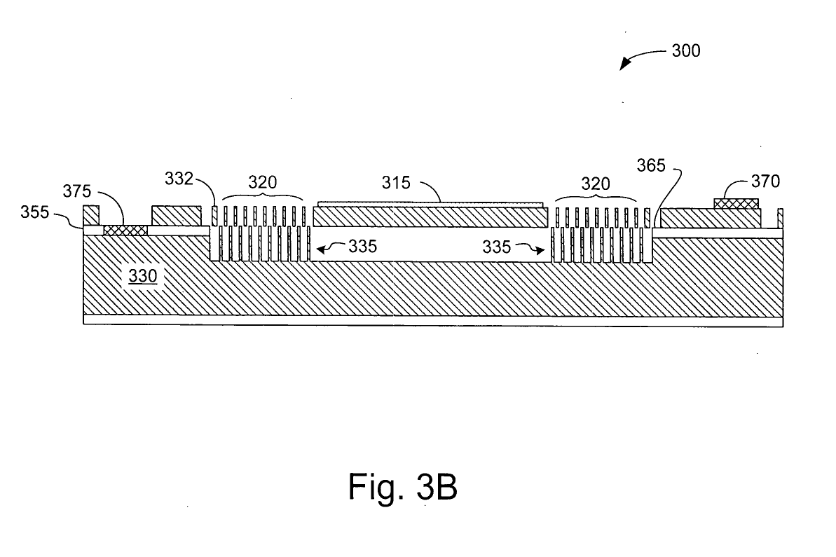

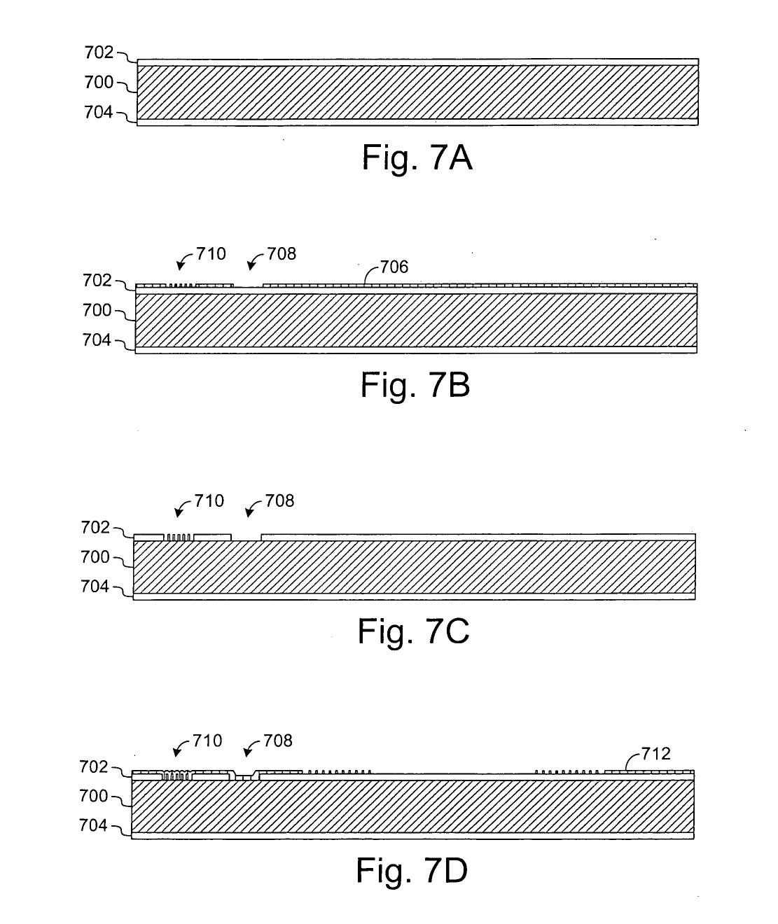

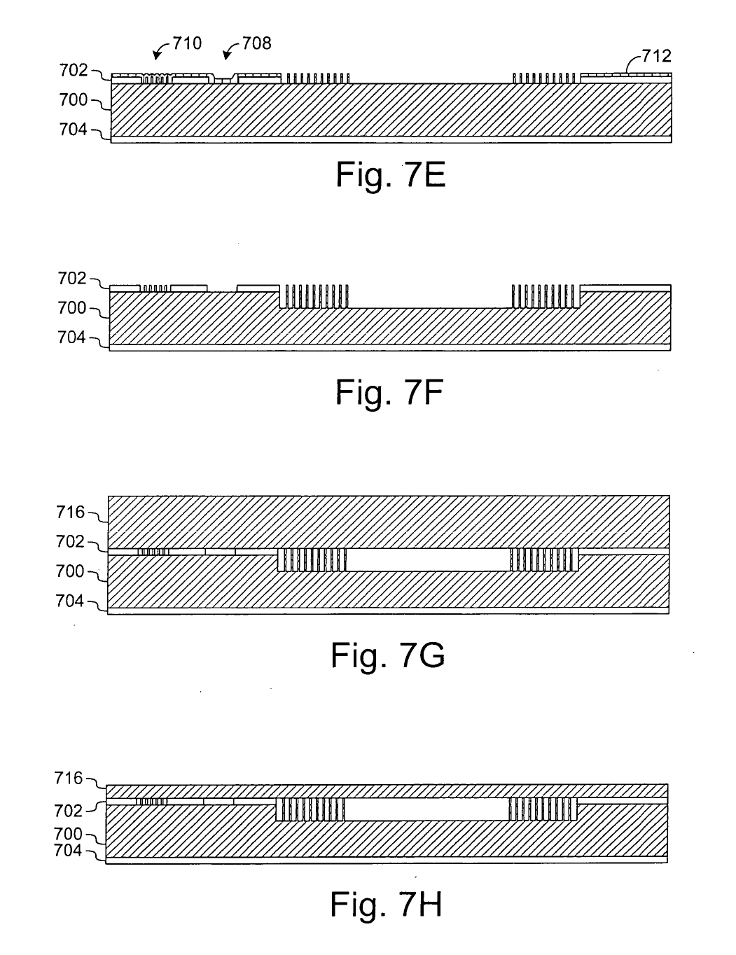

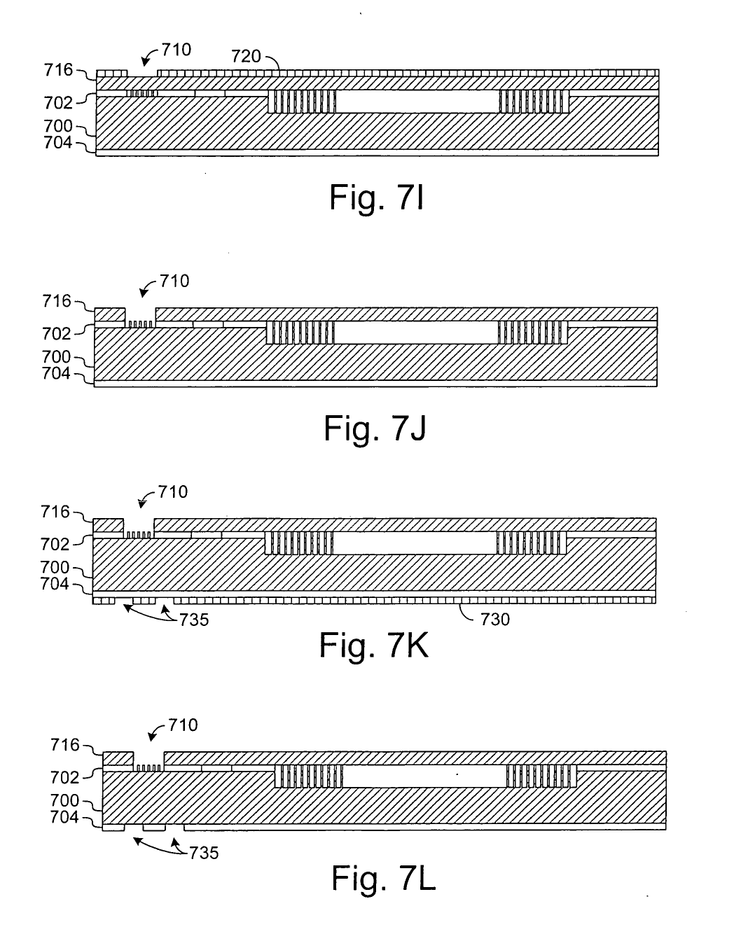

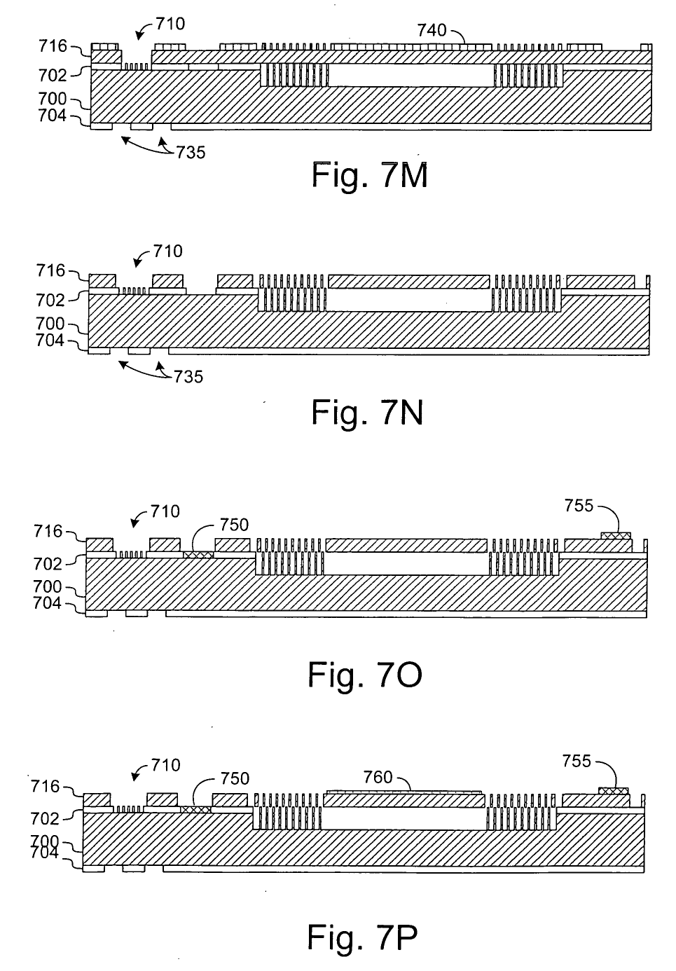

FIG. 3A is a plan view of a uniaxial, Micro-Electro-Mechanical Systems (MEMS) actuator 300 used to implement the bi-stable mirrors of FIGS. 1A, 1B, and 2 in accordance with one embodiment. A fabrication sequence for actuator 300, described along the cross-section of line A-A′, is detailed below in connection with FIG. 7A-7P.

Mirror 300 includes an actuated member 305 that pivots along an axis 307 defined by a pair of torsional hinges 310. Actuated member 305 includes a reflective surface 315, a pair of movable combs 320, and a pair of counterbalances 325. Counterbalances 325 counter combs 320 so that axis 307 intersects the gravitational center of actuated member 305. This balancing greatly reduces unwanted vibrational instability and eliminates vibrational resonances normally associated with unbalanced structures. When the frequency response of the actuator is composed of fundamental torsional resonance and translational resonance at much higher frequencies than the fundamental resonance frequency, servo design and operations are greatly simplified and high servo bandwidth is attainable. Counterbalance 325 and half of mirror 315 in FIG. 3 generate attractive torque with layer 335; however, this electrostatic torque is very small compared with the main driving electrostatic torque between movable combs 320 and stationary combs 335.

Member 305 is supported over a substrate 330 that includes a pair of stationary combs 335. Combs 335 are shown off to the right of actuator 300 for ease of illustration, but in fact extend up from substrate 330 beneath combs 320 so that the teeth of combs 335 are centered within and parallel to the spaces between the teeth of combs 320 from the direction normal to the page. In operation, a voltage potential between combs 320 and corresponding combs 335 produces an electrostatic attraction between the stationary and movable combs, causing combs 320 move toward combs 335. This movement of combs 320 rotates reflective surface 315 along axis 307 to switch optical beams in the manner described in connection with FIGS. 1A, 1B, and 2.

The teeth of combs 320 and 335 interdigitate as combs 320 move toward combs 335. Close spacing of hundreds of nanometers to a few micrometers between interdigitated teeth is desirable, as it increases the electrostatic attraction between the opposing combs and consequently increases the available torque for rotating member 305. Unfortunately, close spacing also increases the possibility of a short between opposing teeth. To combat this, a frame 332 on each movable comb 320 maintains the spacing between the ends of the movable teeth to prevent the teeth from bending to contact the stationary teeth. The stationary teeth of combs 335 do not require such framing, as substrate 330 supports the stationary teeth along their entire length.

Actuated member 305 and substrate 330 are both conductive, highly doped silicon in one example. Actuation requires a voltage be applied between combs 320 and combs 335, so an insulating layer 355 of e.g. silicon dioxide separates the layer in which member 305 is formed from substrate 330. The area 360 surrounding member 305 is formed of the same layer as member 305, but is shaded differently in FIG. 3A to better contrast the operational structures. A ledge 365 patterned into area 360 exposes a portion of insulating layer 355 to increase the physical and resistive separation between the conductive layers (as shown in cross section A-A′ in FIG. 3B). Ledge 365 increases the electrical resistance between layer 360 and the underlying layer supporting teeth 335 because surface electrical conduction generally dominates over bulk conduction for electrical insulators, and ledge 365 extends the surface conduction path between conductive substrate 330 and layer 360 to a length significantly greater than the thickness of insulating layer 355.

Alternatively, region 360 can be held at the same potential as substrate 330 with stationary teeth, in which case ledge 365 may be omitted.

One or more contacts 370 provide electrical contact to actuated member 305. One or more additional contacts 375 extend through area 360 and insulating layer 365 to substrate 330, and consequently to combs 335. In an embodiment of system 200 of FIG. 2, mirror 125 is similar to mirror 330, with the control voltages applied to one or both of pads 370 and ground potential applied to contact 375.

Actuated member 305 can be rotated over a range of angles using a range of applied control voltages applied between movable combs 320 and stationary combs 335. In accordance with one embodiment, this range of motion is limited to two stable positions, each position corresponding to one of two switch positions. In a simple embodiment in which actuator 300 switches a beam between two outgoing waveguides, for example, one switch position might correspond to the unbiased state depicted in FIG. 1A and FIG. 3A, while the second switch position might correspond to a biased condition that introduces a desired degree of mirror deflection. The response of actuator 300 to applied voltages may vary with process variations, so control voltages associated with either or both switch positions can be altered to achieve a desired degree of alignment. In addition, as discussed in connection with FIG. 2, a degree of misalignment can be intentionally imposed in either or both switch positions to reduce or equalize output beam intensity. In this way, one or more communication channels can be equalized without additional components.

The actuator described in FIG. 3A can be also used as a variable optical attenuator when it is combined with a dual-fiber collimator that contains a dual-fiber ferrule and a single lens. Moreover, the same actuator can be incorporated into 1×n switches when it is assembled with (n+1) collimator having (n+1) fibers positioned in a linear array and a single lens.

FIG. 3B is a cross section of actuator 300 of FIG. 3A taken along line A-A′ of FIG. 3A. For ease of illustration, the cross section of FIG. 3B depicts fewer teeth than are shown in FIG. 3A. Hinges 310 that are not shown in cross section A-A′, can be the same thickness as movable combs 320 or can be thinner than the movable combs. Movable parts of comb actuator 300 exhibit electrostatic forces in a direction that is perpendicular to the plane of the actuator and also in the direction that is in the plane of the actuator. Perpendicular forces provide desirable rotation while in-plane forces lead to translational, sideways motion that is undesirable. When high driving voltages are reached, translational forces overcome bending stiffness of hinges and the actuator becomes unstable and moves translationally, resulting in an electrical short and mechanical stiction between stationary and movable combs. It is desirable to shift this translational instability to driving voltages and deflection angles that are well beyond required operating conditions and thus avoid the instability. This condition is easier to achieve when hinge width is larger than hinge thickness. When hinge thickness is the same as movable comb thickness, excessive stiffness is usually obtained with wide hinges, and therefore, hinges thinner than movable combs are preferred.

FIG. 4 depicts a mirror array 400, in accordance with one embodiment, that includes two symmetrical actuators 405 and 410, both of which are similar to actuator 300 of FIGS. 3A and 3B. Actuators 405 and 410 rotate in opposite directions in response to applied control voltages, and are excellent for use as e.g. mirrors 125 and 130 or 140 and 145 of FIGS. 1A and 1B. Actuators 405 and 410 include contacts 415 to the movable combs and a contact 420 to the underlying substrate and fixed combs (not shown). In this example, the top layer 425, the layer in which the movable combs are formed, is electrically isolated from contacts 415 and connected via contact 420 to the underlying stationary combs. In other embodiments, contacts 415 can be electrically connected to the top layer 425.

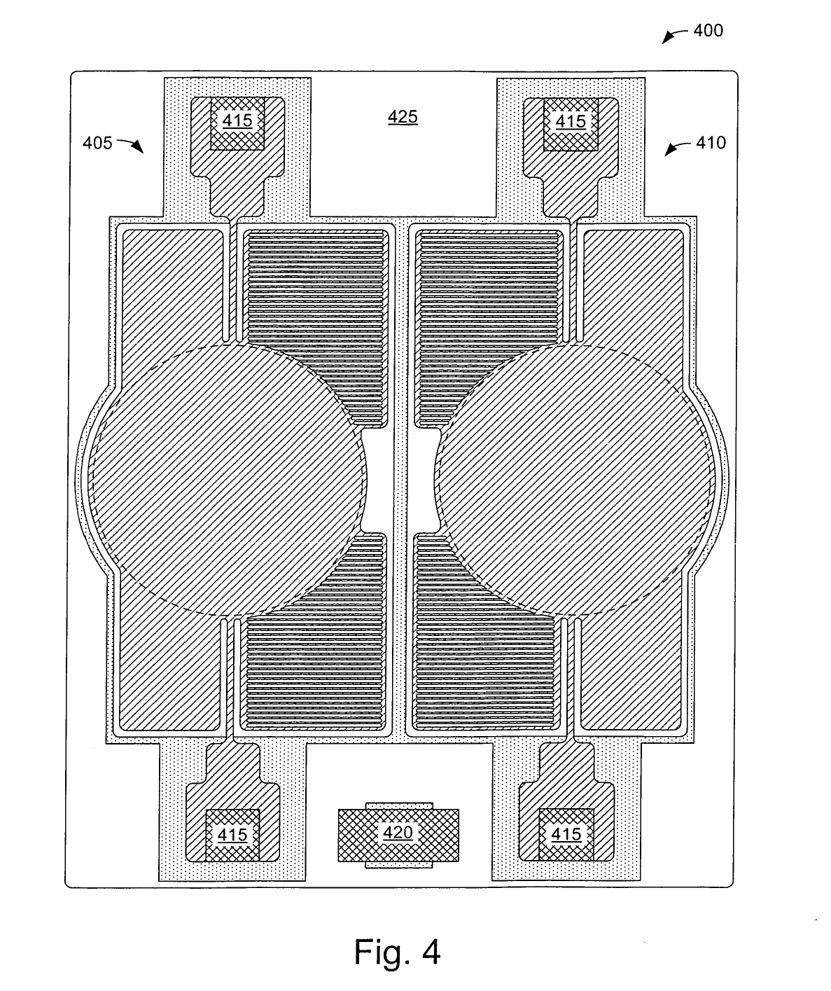

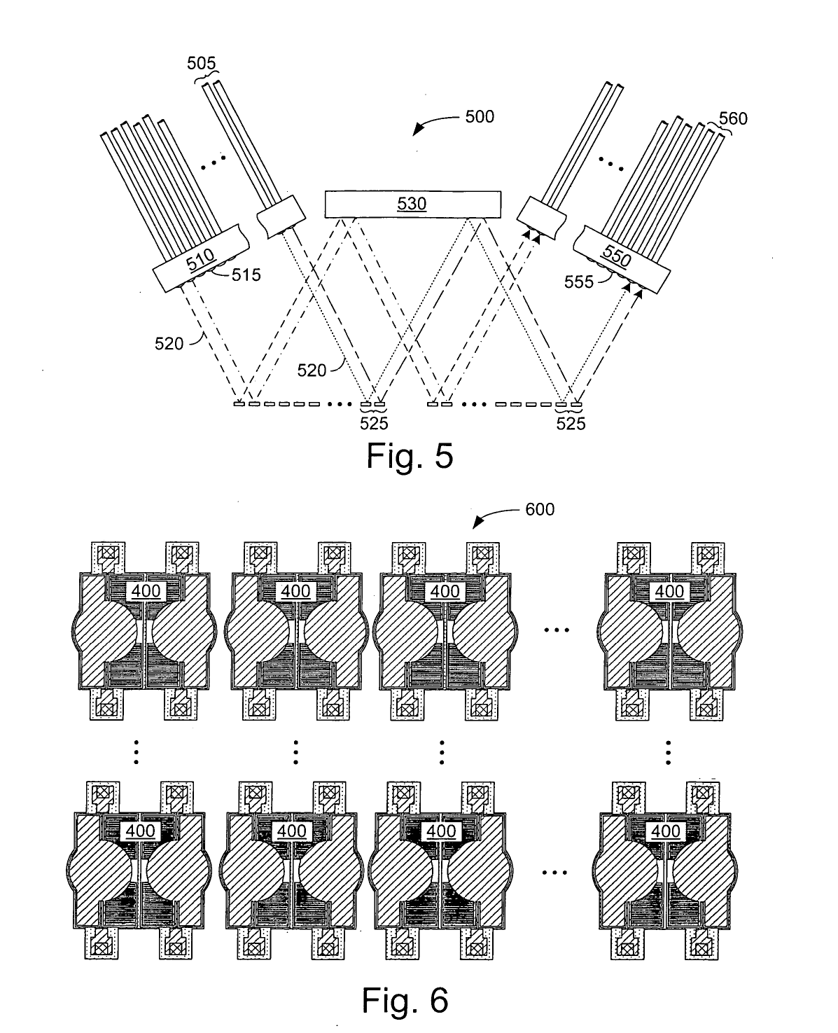

FIG. 5 depicts a switching system 500 illustrating how arrays of bi-stable mirrors of the type described above can be combined to form complex reconfigurable switches such as Reconfigurable Optical Add Drop Multiplexers (ROADMs). System 500 includes an array of input-fiber pairs 505 supported by an alignment structure 510. An array of lenses 515 conventionally collimates beams 520 emitted from the input-fiber pairs. An array of mirror-pairs 525 and a folding mirror 530 direct beams 520 to a second alignment structure 550 supporting a second array of lenses 555 and output fiber pairs 560. The inclusion of folding mirror 530 allows two sets of mirror pairs 525 to be formed together as a single array. In other embodiments, folding mirror 530 is omitted and the switching system reconfigured so paths of beams 520 go directly from the first movable mirror to the next. Such a configuration is discussed in the referenced patent to Novotny, and is omitted here for brevity.

The mirrors in each mirror pair 525 are bi-stable, so that each pair of beams 520 from input fibers 505 can be switched between one pair of outgoing fibers 560. System 500 is therefore operationally identical to the simple system of FIGS. 1A and 1B, but is extended to handle more input and output pairs. The operation of switching system 500 is omitted here for brevity.

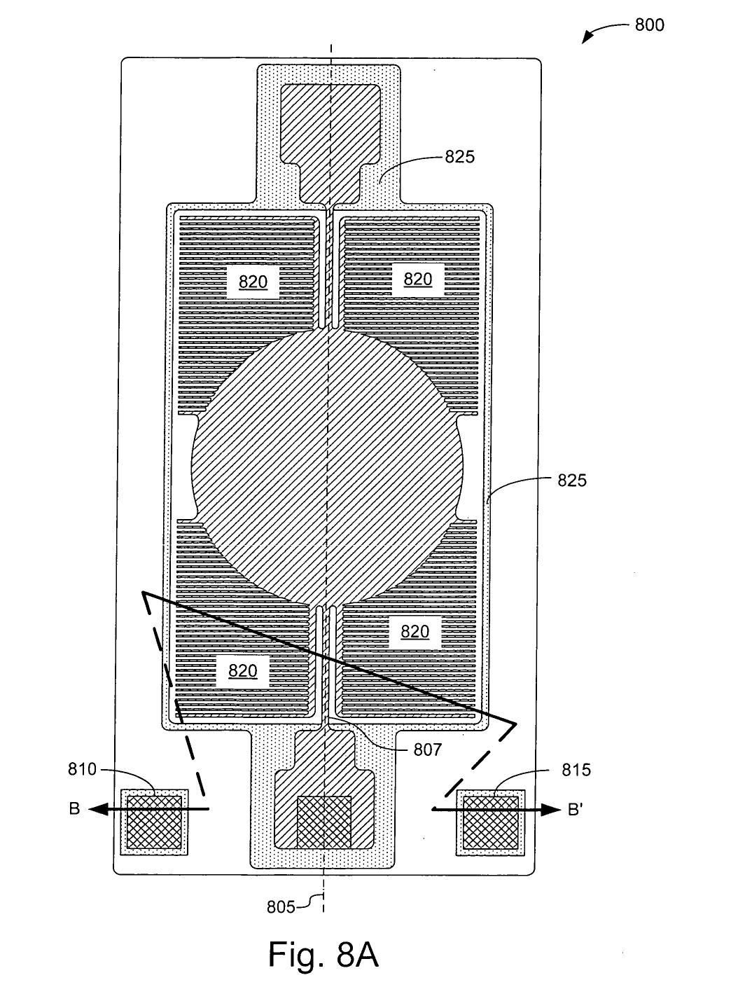

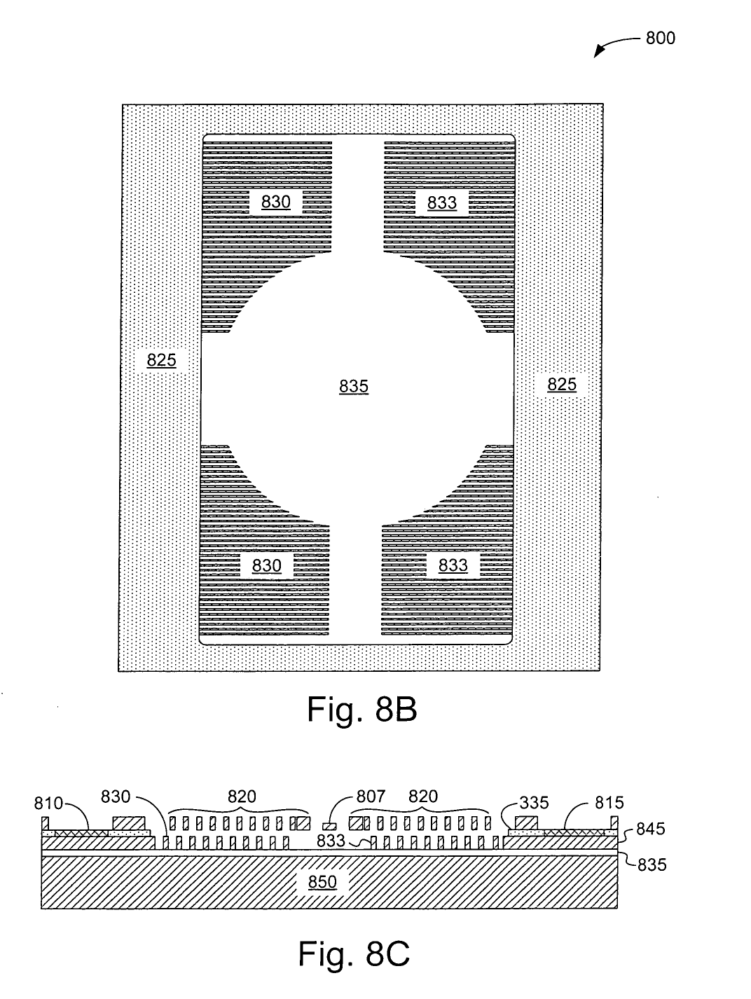

FIG. 6 depicts a mirror array 600 in accordance with another embodiment. Array 500 of FIG. 5 includes linear arrays of fibers and mirrors, but can be extended to include additional rows of fibers and mirrors, if desired. Mirror array 600 has rows and columns of mirror pairs to support such two-dimensional arrangements. Large arrays may require more leads than can easily be connected to the upper surface of array 600 without interfering with the reflected beams. In such cases, the mirrors can be connected to a common voltage (e.g., ground potential) and the stationary combs can be electrically isolated from one another (described in more details in FIGS. 8A and 8B) and contacted from the bottom surface using, for example, a ball-grid array.

FIGS. 7A-7P depict a process sequence used to form one or an array of mirrors in accordance with some embodiments. In this specific example, the resulting structure appears similar to the cross section of actuator 300 depicted in FIG. 3B. The following is a summary of this exemplary process sequence.

FIG. 7A: A heavily doped (n- or p-type) silicon wafer 700 is oxidized to include top and bottom silicon dioxide layers 702 and 704, each about 1 um thick.

FIG. 7B: A patterned photoresist layer 706 exposes oxide layer 702 to define a contact region 708 and alignment marks (region 710).

FIG. 7C: The exposed portions of oxide layer 702 are removed by dry etching and photoresist layer 706 is removed.

FIG. 7D: A patterned photoresist layer 712 defines the teeth of combs 335. (A number of teeth are omitted here for clarity.) Though not shown, alignment marks can also be patterned in this step.

FIG. 7E: The exposed portions of oxide layer 702 are removed by dry etching.

FIG. 7F: The structure of FIG. 7E is subjected to a reactive ion etch to remove about 40 um of the exposed surface of wafer 700 and photoresist layer 712 is removed.

FIG. 7G: A second, unpatterned, silicon wafer 716, heavily doped (n- or p-type), is bonded to oxide layer 702.

FIG. 7H: Wafer 716 is thinned, to about 30 um in one example.

FIG. 7I: A patterned photoresist layer 720 exposes layer 716 above the alignment marks of region 710.

FIG. 7J: The structure of FIG. 7I is subjected to a reactive ion etch to expose the alignment marks of region 710 and photoresist layer 720 is removed.

FIG. 7K: A patterned photoresist layer 730 on the bottom surface of oxide layer 704 patterns backside alignment marks in areas 735.

FIG. 7L: The exposed portions of oxide layer 704 are removed by dry etching to form alignment marks in areas 735, after which photoresist mask 730 is removed.

FIG. 7M: A photoresist mask 740 patterns the upper layer of actuator 300, including area 360 and actuated member 305. Exposed alignment marks 710 allow a high degree of alignment between top movable and bottom stationary teeth. Movable teeth have to be positioned symmetrically between stationary teeth in order to shift translational instability to high voltages compared with driving voltages. The features most evident in this cross section are the portions of mask 740 defining the teeth of combs 320. (A number of teeth in combs 320 are omitted here for clarity.) Though not shown, mechanical separation lines between actuator arrays are also defined. In order to further decrease sensitivity to translational instability in which movable structure moves sideways, in plane of FIG. 3A, thin, wide hinges may be fabricated. In this case, a double mask of hard masking material, such as silicon dioxide, and photoresist is used to form hinges that are thinner than the movable teeth and mirror. (A number of exemplary processes for forming hinges that are thin relative to comb teeth are detailed in U.S. patent application Ser. No. 10/028,657 entitled “Pattern-Transfer Process for Forming Micro-Electro-Mechanical Structures,” by Vlad J. Novotny, which is incorporated herein by reference.)

FIG. 7N: A reactive ion etch (RIE) removes exposed portions of layer 716, after which mask 740 is removed. The etch process employed preferably exhibits minimal undercutting and relatively smooth walls. This step releases the movable portions of the actuator being formed (e.g., combs 320 and counterbalance 325 of FIG. 3). Small structures can heat excessively in response to the RIE process, particularly during the removal of the last few microns of material. The RIE process is therefore slowed as the release step nears completion to allow structures in layer 716 to cool. The RIE process can be slowed either by applying power intermittently, reducing etch power, or both. This “silicon release” process facilitates the formation of ledges 365 (FIG. 3). The etch process thus etches through a first portion of conductive layer 716 at a first etch rate and etches through a second portion of conductive layer 716 at a second etch rate slower than the first etch rate. This slower etch rate is continued until the structure of FIG. 7N results.

FIG. 7O: Contacts 750 and 755 are metalized using a shadow mask and metal is diffused into the silicon to form low resistance contacts.

FIG. 7P: Finally, a mirror surface 760 is added using a metalization process that deposits an adhesion layer (e.g. chromium or titanium) and a reflective layer (e.g. gold) through a shadow mask. In an alternative embodiment, metal layer are deposited over the full wafer surface and electrical pads and/or mirrors are then defined by photolithography and etching or by liftoff process. When these optional process steps are chosen, they are implemented before structure release in FIG. 7N. The process described in FIGS. 7 A to 7P provide release of actuator by silicon etch. Minor modifications of this basic process permit actuator release by etching dielectric layer, usually silicon dioxide.

FIG. 8A depicts a uniaxial, bi-directional actuator 800 in accordance with another embodiment. Actuator 800 is similar to actuator 300 of FIGS. 3A and 3B, except that the portions to the right of axis 307 in FIG. 3A appear in actuator 800 on both sides of a rotational axis 805 defined along a hinge 807, and the stationary combs (FIG. 8B) on either side of rotational axis 805 are separately controlled using a corresponding pair of contacts 810 and 815. Actuator 800 can be tilted in either direction along axis 805 by applying a voltage difference between the depicted movable combs 820 and the appropriate set of underlying stationary combs. The movable portions, including combs 820 and hinges 807, are separated from the underlying stationary portions by an insulating layer 825.

FIG. 8B is a plan view depicting a portion of actuator 800 with the top conductive layer removed to show the underlying pairs of fixed combs 830 and 833, which are formed in a conductive silicon layer disposed between top insulating layer 825 and bottom insulating layer 835.

FIG. 8C is a cross section of actuator 800 taken along line B-B′ of FIG. 8A. Fabrication is similar to the process outlined above in connection with FIGS. 7A-7P, but actuator 800 is formed on an silicon-on-insulator wafer consisting of a silicon layer 845 and silicon substrate 850 separated by insulating layer 835. The teeth of stationary combs 833 are in electrical contact with the portion of layer 845 underlying contact 815, so the voltage on combs 833 can be modulated via contact 815. Similarly, the teeth of stationary combs 830 are in electrical contact with the portion of layer 846 underlying contact 810, so the voltage on combs 830 can be modulated via contact 810. Insulating layer 835 electrically isolates fixed combs 830 and 833 to allow application of disparate control voltages. The hinge shown in FIG. 8C is thinner than movable combs 820.

The switching systems described above use uniaxial, unidirectional mirrors to switch between pairs of output waveguides. Alternative embodiments can use uniaxial, bidirectional actuators like actuator 800 for the same purpose. Alternatively, either unidirectional or bidirectional mirrors can be used to switch between more than two output waveguides. Actuator 800 may be better suited for such embodiments, as the provision of two directions of rotation increases the range of rotational motion but with additional complexity of fabrication.

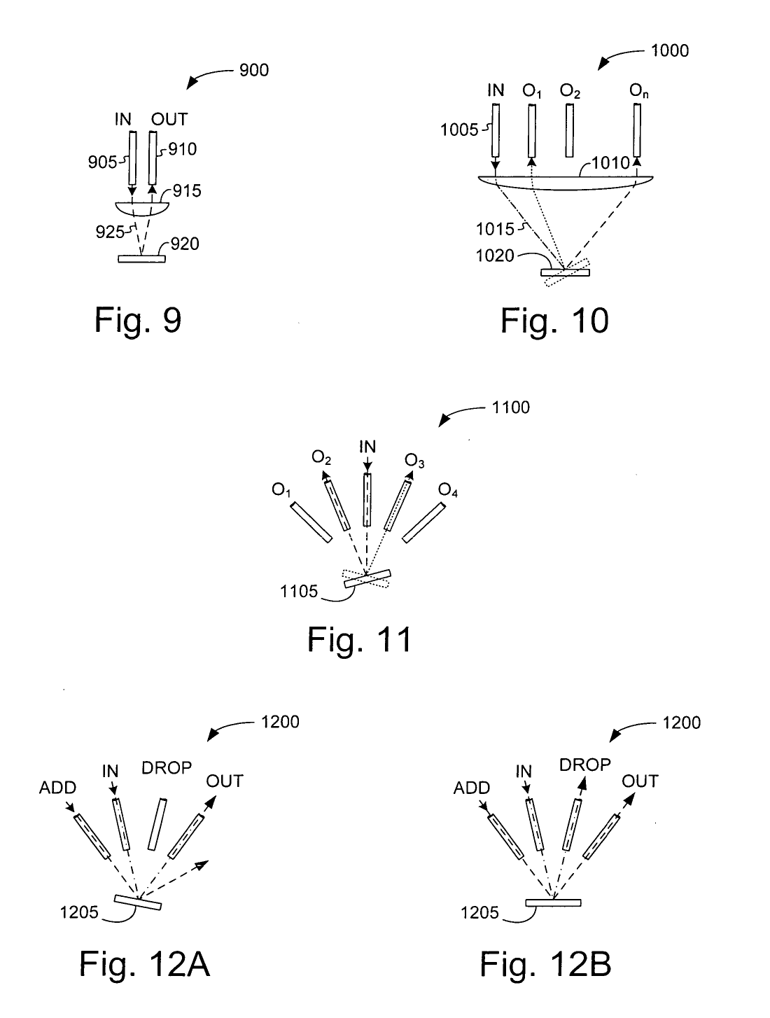

FIGS. 9 through 12B depict systems that include uniaxial, unidirectional and/or bidirectional mirrors of the types depicted in e.g. FIG. 3A and 8A. These systems benefit from the many advantageous characteristics of the actuators described above, including ease of fabrication, high frequency response, low driving voltages, high electrical isolation, and low power consumption.

FIG. 9 depicts an optical attenuator 900 that includes an input fiber 905, and output fiber 910, a lens 915, and an actuator 920 similar to one of the uniaxial mirrors described herein. The fibers and lens are, in one embodiment, a dual fiber optical collimator and in another embodiment dual fiber ferrule and separate lens. Actuator 920 reflects an incoming beam 925 out through output fiber 910. The intensity of the resulting output beam can be adjusted by altering the deflection angle of actuator 920. Attenuator 900 can also be used as a switch, in which case actuator might be calibrated for maximum output coupling in one state and to reflect beam 925 entirely away from fiber 910 in another state.

FIG. 10 depicts an optical switch 1000 that includes an input fiber 1005 and n output fibers 0₁ through oₙ. A lens 1010 directs an incoming beam 1015 toward an actuator 1020 similar to one of the uniaxial mirrors described herein. Actuator 1020 reflects beam 1015 to a given one of the output fibers based on the selected deflection angle. Switch 1000 can also act as an attenuator by fine tuning the deflection angle in a given switch position.

FIG. 11 depicts an optical switch 1100 in which an actuator 1105 switches a beam from an input fiber IN to one of four output fibers 0₁ through 0₄. The fibers can have fiber grin lenses or conventional lenses formed at the end of the fibers, aligned radially, so separate lenses are not required. Other embodiments use standard fibers aligned radially in combination with separate lenses. Input fiber IN is between the output fibers and bi-directional actuator 1105 tilts in two directions along a signal axis to switch between the output fibers. Switch 1100 can also act as an attenuator by fine tuning the deflection angle in a given switch position.

FIGS. 12A and 12B depict two positions of an ADD/DROP multiplexer 1200 in accordance with one embodiment. FIG. 12A depicts an IN/OUT position in which an actuator 1205 is angled to reflect an input beam IN to an output fiber OUT. An add beam ADD, if any, bypasses the outgoing fibers. FIG. 12B depicts a second switch position in which actuator 1205 is angled to reflect a input beam IN to a drop fiber DROP and add beam ADD to output fiber OUT.

While the present invention has been described in connection with specific embodiments, variations of these embodiments will be obvious to those of ordinary skill in the art. For example,

1. Electromagnetically, piezoelectrically, or thermally driven actuators can be used;

2. Bulk micromachining methods described above can be substituted with surface micromachining methods;

3. Optical waveguides include constant cross section waveguides, tapered waveguides, conventional single-mode and multimode optical fibers, lensed and grin fibers with straight or angled facets, with or without antireflective coatings. Lensed and grin fibers allow smaller fiber-to-fiber spacings, smaller switching mirrors and shorter fiber-to-fiber propagation distances than normal cleaved fibers with simpler fabrication and wider tolerances while keeping insertion losses to minimum.

Therefore, the spirit and scope of the appended claims should not be limited to the foregoing description.

What is claimed is:

1. An electrostatic actuator comprising:
a. an actuated member;
b. a first comb extending from the actuated member, the first comb including a first plurality of comb teeth having a first plurality of interconnected tooth ends and a second plurality of interconnected tooth ends;
c. a second comb including a second plurality of comb teeth interdigitated to an extent with the first plurality of comb teeth; and
d. a voltage source applying a bias voltage between the first and second combs;
e. wherein increasing the bias voltage increases the extent to which the first and second pluralities of comb teeth are interdigitated.

2. The actuator of claim 1, the first comb including a frame, and wherein the frame interconnects the second plurality of interconnected tooth end.

3. The actuator of claim 1, wherein the actuated member comprises a mirror.

4. The actuator of claim 1, wherein the actuated member pivots on an axis of rotation.

5. The actuator of claim 4, wherein the actuated member has a center of gravity, and wherein the axis of rotation intersects the center of gravity.

6. The actuator of claim 5, wherein the first plurality of teeth do not extend across the axis of rotation.

7. The actuator of claim 1, wherein the actuator is part of a variable optical attenuator.

8. The actuator of claim 1, wherein the actuator is part of a one-by-n switch.

9. The actuator of claim 8, wherein the switch includes a collimator having n fibers.

10. The actuator of claim 9, wherein the fibers are focused using at least one focusing element selected from the group consisting of a single lens common to multiple ones of the n fibers, grin fibers, fiber lenses, discrete lenses, and lens arrays.

11. An actuator comprising:
a. a first electrical contact connected to a first voltage source;
b. a second electrical contact connected to a second voltage source;
c. a first conductive layer connected to the first voltage source via the first electrical contact;
d. a second conductive layer connected to the second voltage source via the second electrical contact; and
e. an insulating layer of an insulating-layer thickness disposed between the first and second conductive layers;
f. wherein a portion of the first conductive layer approaches the second conductive layer in response to a voltage potential applied between the first and second electrical contacts; and
g. wherein the insulating layer forms a ledge separating the first and second conductive layers by a surface conduction path greater than the insulating layer thickness.

12. The actuator of claim 11, wherein the first conductive layer includes a first comb having a first plurality of teeth and the second conductive layer includes a second comb having a second plurality of teeth, and wherein the first and second pluralities of teeth are interdigitated from a perspective normal to the first conductive layer.

13. The actuator of claim 11, further comprising a mirror surface disposed on the first conductive layer.

14. The actuator of claim 13, further comprising an input fiber directing a light beam at the mirror surface to produce a reflected beam and an output fiber receiving at least a portion of the reflected beam, wherein the portion is of an intensity determined by the applied voltage potential.

15. The actuator of claim 14, further comprising a second output fiber, wherein the mirror surface directs the reflected beam to the second output fiber in response to a second applied voltage potential.

16. The actuator of claim 11, wherein the first conductive layer is patterned using an etch process, and wherein the etch process etches through a first portion of the first conductive layer at a first etch rate and etches through a second portion of the first conductive layer at a second etch rate slower than the first etch rate.

17. The actuator of claim 11, wherein the actuator is part of a variable optical attenuator.

18. The actuator of claim 11, wherein the actuator is part of a one-by-n switch.

19. The actuator of claim 18, wherein the switch includes a collimator having n fibers.

20. The actuator of claim 19, wherein the fibers are focused using at least one focusing element selected from the group consisting of a single lens common to multiple ones of the n fibers, grin fibers, fiber lenses, discrete lenses, and lens arrays.

21. An actuator comprising:
a. a substrate;
b. an actuated member connected to the substrate and having a rotational axis parallel to the substrate;
c. first and second movable combs extending from the actuated member on either side of the rotational axis from a perspective normal to the substrate;
d. first and second fixed combs connected to the substrate, wherein the first and second fixed combs are on opposite sides of the rotational axis from the perspective normal to the substrate; and
e. a hinge connecting the movable combs to the substrate, the hinge having a hinge thickness in a dimension normal to the substrate and a hinge width in a dimension parallel to the substrate, wherein the hinge thickness is less than the hinge width.

22. The actuator of claim 21, wherein the actuated member comprises a mirror surface.

23. The actuator of claim 21, wherein the actuator is part of a variable optical attenuator.

24. The actuator of claim 21, wherein the movable combs have a comb thickness in the dimension normal to the substrate, and wherein the comb thickness is greater than the hinge thickness.

25. The actuator of claim 21, wherein the actuator is part of a one-by-n switch.

26. The actuator of claim 25, wherein the switch includes a collimator having n fibers.

27. The actuator of claim 26, wherein the fibers are focused using a focusing element selected from the group consisting of a single lens common to multiple one of the n fibers, grin fibers, fiber lenses, discrete lenses, and lens arrays.
